(19) United States
(12) Patent Application Publication
(10) Pub. No.: US 2026/0188555 A1
(43) Pub. Date: Jul. 2, 2026

(54) COIL COMPONENT

(71) Applicant: SAMSUNG ELECTRO-MECHANICS CO., LTD., Suwon-si (KR)

(72) Inventors: Byeong Cheol MOON, Suwon-si (KR); Jin Hwan KIM, Suwon-si (KR); Hwan Su SIM, Suwon-si (KR); Tae Hoon KIM, Suwon-si (KR)

(73) Assignee: SAMSUNG ELECTRO-MECHANICS CO., LTD., Suwon-si (KR)

(21) Appl. No.: 19/392,308

(22) Filed: Nov. 18, 2025

(30) Foreign Application Priority Data
Dec. 26, 2024 (KR) 10-2024-0197459

(51) Int. Cl. H01F 27/24; H01F 1/147; H01F 27/32

(52) U.S. Cl. CPC H01F 27/24; H01F 1/14766; H01F 27/323

(57) ABSTRACT

A coil component includes a first body containing a first magnetic material and a second body disposed on an upper surface of the first body, the second body containing a second magnetic material. An insulating layer is disposed on an upper surface of the second body, and a coil is at least partially disposed in the second body and extends to a surface of the second body. The first magnetic material has a saturation magnetostriction constant that is smaller than the saturation magnetostriction constant of the second magnetic material, thereby reducing magnetostriction in a lower portion of the coil component and suppressing acoustic noise.

### CROSS-REFERENCE TO RELATED APPLICATION(S)

This application claims the benefit of priority to Korean Patent Application No. 10-2024-0197459 filed on Dec. 26, 2024 with the Korean Intellectual Property Office, the disclosure of which is incorporated herein by reference in its entirety.

### TECHNICAL FIELD

The present disclosure relates to a coil component.

When a periodic pulse is applied to the coil component, vibrations may be induced. Such vibrations may cause fine deformation of a substrate through the external electrode. When a resonance frequency of the substrate or a mounted component corresponds to a resonance frequency of the vibrations, acoustic noise may occur due to amplified vibrations. Such amplified vibrations may generate acoustic noise through the entire substrate, and may cause interference depending on a usage environment. Accordingly, in coil components used for sensitive applications, reducing acoustic noise may be one of the most important technical challenges.

### SUMMARY

An aspect of the present disclosure is to provide a coil component having reduced acoustic noise.

According to an aspect of the present disclosure, there is provided a coil component including a first body including a first magnetic material, a second body disposed on an upper surface of the first body, the second body including a second magnetic material, an insulating layer disposed on an upper surface of the second body, and a coil at least partially disposed in the second body, the coil extending to a surface of the second body. A saturation magnetostriction constant of the first magnetic material may be less than a saturation magnetostriction constant of the second magnetic material.

According to example embodiments of the present disclosure, a coil component may have reduced acoustic noise.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view of a coil component according to a first example embodiment of the present disclosure;

FIG. 2 is a schematic cross-sectional view taken along line I-I′ of FIG. 1;

FIGS. 3A, 4A, 5A are enlarged views of regions “A” of FIG. 2;

FIGS. 3B, 4B, 5B are enlarged views of regions “B” of FIG. 2;

FIGS. 6 to 9 are views of various modifications of a first example embodiment of the present disclosure;

FIG. 10 is a perspective view of a coil component according to a second example embodiment of the present disclosure;

FIG. 11 is a schematic cross-sectional view taken along line II-II′ of FIG. 10;

FIG. 12 is a view of a modification of a second example embodiment of the present disclosure;

FIG. 13 is a perspective view of a coil component according to a third example embodiment of the present disclosure;

FIG. 14 is a schematic cross-sectional view taken along line III-III′ of FIG. 13;

FIG. 15 is a view of a modification of a third example embodiment of the present disclosure; and

FIG. 16 is a view of another modification of a third example embodiment of the present disclosure.

### DETAILED DESCRIPTION

The terms used herein are for the purpose of describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this code, specify the presence of stated features, integers, steps, operations, elements, components or a combination thereof, but do not preclude the presence or addition of one or more other features, integers, steps, operations, elements, components, and/or groups thereof. In addition, the terms “disposed on,” “positioned on,” and the like, may mean that an element is positioned on or below a target portion, and may not necessarily mean that the element is positioned on an upper side of the target portion with respect to a direction of gravity.

The terms “coupled to,” “connected to,” and the like, may not only indicate that elements are directly and physically in contact with each other, but also include a configuration in which another element is interposed between the elements such that the elements are also in contact with the other element.

The size and thickness of each element illustrated in the drawings are arbitrarily represented for ease of the description, but the present disclosure is not limited to those illustrated herein.

In the drawings, an X-direction may be defined as a first direction or a length direction, a Y-direction may be defined as a second direction or a width direction, and a Z-direction may be defined as a third direction or a thickness direction.

In the entire specification, the term “lamination direction” may refer to a direction in which elements are sequentially laminated, and may correspond to a “thickness direction” that is perpendicular to wider surfaces (main surfaces) of elements on a sheet. In the drawings, the term “lamination direction” may correspond to a Z-direction (third direction).

Hereinafter, a coil component according to an example embodiment of the present disclosure will be described in detail with reference to the accompanying drawings. In the description with reference to the accompanying drawings, the same or corresponding elements are denoted by the same reference numerals and repeated descriptions thereof will be omitted.

Various types of electronic components may be used in electronic devices, and various types of coil components may be appropriately used between such electronic components to remove noise.

That is, in an electronic device, a coil component may be used as a power inductor, a high frequency (HF) inductor, a general bead, a high-frequency bead (GHz bead), a common mode filter, or the like.

### First Example Embodiment

A coil component 1000 according to a first example embodiment may be a thin-film type coil component.

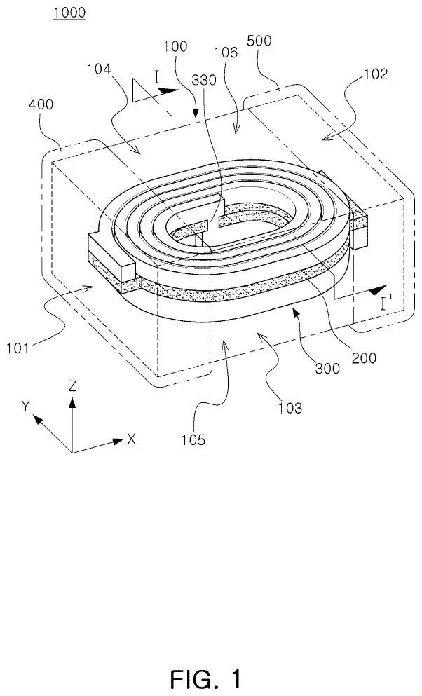

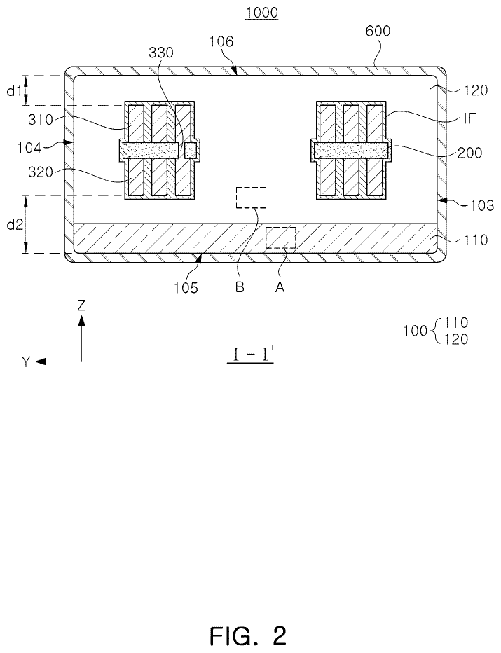

FIG. 1 is a perspective view of a coil component according to the first example embodiment of the present disclosure. FIG. 2 is a schematic cross-sectional view taken along line I-I′ of FIG. 1.

Referring to FIGS. 1 and 2, the coil component 1000 according to the first example embodiment of the present disclosure may include a body 100, a support member 200, a coil 300, external electrodes 400 and 500, and an insulating layer 600, and may further include an insulating film IF.

The body 100 may form an exterior of the coil component 1000 according to the present example embodiment, and may include the coil 300 buried therein.

The body 100 may have an overall hexahedral shape.

Hereinafter, an example embodiment of the present disclosure will be described on the assumption that the body 100 has a hexahedral shape. However, the description does not exclude a coil component including a body having a shape other than a hexahedral shape from the scope of the present example embodiment.

The body 100 may include a first surface 101 and a second surface 102 opposing each other in an X-direction (first direction), a third surface 103 and a fourth surface 104 opposing each other in a Y-direction (second direction), and a fifth surface 105 and a sixth side surface 106 opposing each other in a Z-direction (third direction). The third to sixth surfaces 103, 104, 105, and 106 of the body 100 may respectively correspond to a plurality of side surfaces of the body 100, connecting the first surface 101 and the second surface 102 of the body 100 to each other. When the coil component 1000 according to the present example embodiment is mounted on a mounting substrate such as a printed circuit board, the fifth surface 105 of the body 100 may be disposed to face a mounting surface of the mounting substrate, thereby allowing the coil component to be mounted on the mounting substrate.

The body 100 may be formed such that the coil component 1000 according to the present example embodiment, including the external electrodes 400 and 500 and the insulating layer 600 to be described below, has a length of 2.0 mm, a width of 1.2 mm, and a thickness of 0.65 mm, but the present disclosure is not limited thereto. Tolerances are excluded from the above-described values of the length, width, and thickness of the coil component, and thus actual length, width, and thickness of the coil component may have values different from the above-described values due to tolerances.

Referring to FIG. 2, the body 100 may include a first body 110 and a second body 120 disposed on the first body. The body 100 may have different metal magnetic particle size distributions, compositions, or the like, as will be described below, and may be divided into the first body 110 and the second body 120, based on such differences. Each of the first body 110 and the second body 120 may have a hexahedral shape, but the present disclosure is not limited thereto.

The first body 110 may be disposed on a lower portion of the second body 120. One surface (a lower surface) of the first body 110 may form the fifth surface 105 of the body 100. The other surface (an upper surface) of the first body 110 may have the second body 120 disposed thereon. A plurality of side surfaces of the first body 110 may form a portion of a plurality of side surfaces of the body 100.

The first body 110 may be disposed on a lower portion of the coil 300. That is, the coil 300 may not be disposed in the first body 110. However, the present disclosure is not limited thereto. As in a modification to be described below, at least a portion of the coil 300 may be disposed in the first body 110.

The second body 120 may be disposed on the other surface (upper surface) of the first body 110. One surface (lower surface) of the second body 120 may be in contact with the first body 110. The other surface (upper surface) of the second body 120 may form the sixth surface 106 of the body 100. A plurality of side surfaces of the second body 120, together with a plurality of side surfaces of the first body 110, may form a plurality of side surfaces 103, 104, 105, and 106 of the body 100.

The insulating layer 600 to be described below may be disposed on the upper surface of the second body 120. That is, the second body 120 may form an upper region of the body 100, and may be disposed above other body elements (the first body and the third body).

At least a portion of the coil 300 may be disposed in the second body 120. The second body 120 may include a core passing through the coil 300.

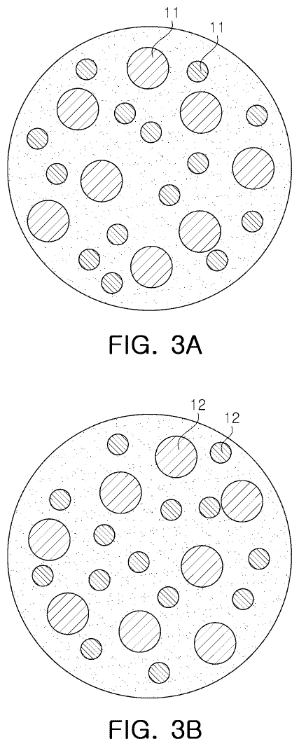

FIGS. 3A, 4A, 5A are enlarged views of regions “A” of FIG. 2. FIGS. 3B, 4B, 5B are enlarged views of regions “B” of FIG. 2;

Referring to FIG. 3A, the first body 110 may include a first magnetic material 11 and a resin. The first body 110 may have a structure in which the first magnetic material 11 is dispersed in the resin. The first body 110 may include two or more types of magnetic materials dispersed in the resin. Here, different types of magnetic materials may mean that the magnetic materials dispersed in the resin are distinguished from each other in terms of at least one of an average diameter, a composition, crystallinity, or a shape. For example, as illustrated in FIGS. 3A and 3B, the first magnetic material 11 may include a plurality of magnetic particles having different particle diameters.

As will be described below, the body 100 may further include a fourth magnetic material 14, and a saturation magnetostriction constant of the fourth magnetic material 14 may be greater than that of the first magnetic material 11. For ease of description, the fourth magnetic material 14 is not illustrated in FIGS. 3A and 3B, but a case in which the first body 110 of the present disclosure includes the fourth magnetic material 14 is not excluded.

The first body 110 may include a resin. The resin may include epoxy, polyimide, a liquid crystal polymer (LCP), or combinations thereof alone or in combination, but the present disclosure is not limited thereto.

Similarly, the second body 120 may include a second magnetic material 12 and a resin, and may have a structure in which the second magnetic material 12 is dispersed in the resin. A detailed description of the second body 120 may overlap that of the first body 110, and thus is omitted.

The coil component 1000 according to the present example embodiment may include the first body 110 and the second body 120 including magnetic materials having different saturation magnetostriction constants.

A magnetostriction effect may refer to a phenomenon in which a physical size (length or volume) of a magnetic material changes when the magnetic material is magnetized by a magnetic field. A body material of a coil component may exhibit a magnetostriction property of about 20 parts per million (ppm). For example, a saturation magnetostriction constant of Fe-3.5% Si may be about 7.8 ppm, a saturation magnetostriction constant of a Fe-based amorphous material may be about 20 to 30 ppm, and a saturation magnetostriction constant of Fe-50% Ni may be about 25 ppm.

Accordingly, a length of the magnetic material may change according to a flow of magnetic flux in the coil component, and such change may periodically occur in synchronization with change of an external magnetic field. In particular, when a periodic pulse is applied to the coil component, vibrations may be induced. Such vibrations may cause fine deformation of a substrate through the external electrode. When a resonance frequency of the substrate or a mounted component corresponds to a resonance frequency of the vibrations, acoustic noise may occur due to amplified vibrations. A magnitude of the noise may be proportional to an amplitude of the substrate, and a magnitude of the amplitude may be proportional to a magnetostriction magnitude of the magnetic material.

Accordingly, as a method for reducing acoustic noise of the coil component, a method for adjusting a saturation magnetostriction constant of the magnetic material, and a method for minimizing magnetostriction through structural changes of the coil component, may be considered. In particular, a method of adjusting a saturation magnetostriction constant and a magnetic flux density of a lower portion of the coil component adjacent to the substrate may be effective.

The coil component according to the present disclosure may be configured such that the coil 300 is disposed to be biased toward an upper surface of the body. Specifically, referring to FIG. 2, a distance d2 from an upper surface of the coil 300 to the other surface (upper surface) of the second body 120 may be less than a distance d1 from a lower surface of the coil 300 to one surface (lower surface) of the first body 110. As an area of a lower portion of the coil 300 through which magnetic flux passes increases, a magnetic flux density of the lower portion of the coil 300 may be reduced.

The saturation magnetostriction constant may be a physical constant indicating a degree of deformation of a magnetic material by a magnetic field. When a magnetic material having a small saturation magnetostriction constant is used, physical deformation caused by a given magnetic field intensity may be reduced, and noise may be reduced.

In the coil component according to the present disclosure, a saturation magnetostriction constant of the first magnetic material 11 may be less than a saturation magnetostriction constant of the second magnetic material 12. Because the saturation magnetostriction constant of the first magnetic material 11 is less than the saturation magnetostriction constant of the second magnetic material 12, a magnetostriction phenomenon occurring in the lower portion of the coil component may be reduced, and acoustic noise may be effectively controlled.

Specifically, the saturation magnetostriction constant of the first magnetic material 11 may have a negative value, or may have a value of 1 ppm or less. In particular, when the saturation magnetostriction constant of the first magnetic material 11 has a negative value, a magnetostriction phenomenon, caused by other magnetic materials such as a fourth magnetic material 14 and the like, may be offset.

Conversely, the saturation magnetostriction constant of the second magnetic material 12 may have a positive value, specifically a value greater than 1 ppm.

When the first body 110 includes the first magnetic material 11 and the fourth magnetic material 14, both the first magnetic material 11 and the fourth magnetic material 14 may not need to have saturation magnetostriction constants less than that of the second magnetic material 12. For example, when the first magnetic material 11 has a sufficiently small saturation magnetostriction constant value, the above-described magnetostriction phenomenon may be reduced.

Similarly, when the first body 110 includes the first magnetic material 11 and the fourth magnetic material 14, both the first magnetic material 11 and the fourth magnetic material 14 may not need to have negative saturation magnetostriction constant values or values of 1 ppm or less. For example, when the saturation magnetostriction constant of the first magnetic material 11 has a negative value, the above-described magnetostriction phenomenon may be reduced.

A saturation magnetostriction constant of a magnetic material according to the present disclosure may be measured using the following method. First, cross-sectional samples of the first body 110 and the second body 120 may be collected. The cross-sectional sample may be obtained from one cross-section of the body 100, for example, a cross-section in a second direction-third direction (Y-Z) of a middle portion of the body 100 in a first direction (X-direction) in FIG. 2. Samples of the second body 120 and the first body 110 may be collected from upper and lower regions of the obtained cross-section, respectively, based on the coil 300. The saturation magnetostriction constant may be an average of values measured for a plurality of magnetic materials in the cross-sectional samples. In addition, the saturation magnetostriction constant may be calculated by averaging a plurality of values measured from a plurality of cross-sections. Here, the plurality of cross-sections may be taken at a regular interval in one direction (for example, five cross-sections at an interval of 100 μm).

An AC or DC magnetic field may be applied to the collected samples, and an intensity of the magnetic field may be gradually changed. In this case, deformation (length) of the magnetic material that occurs may be measured using a piezoelectric element (electromagnetic method) or a laser interferometer (optical method). For example, a PZT piezoelectric element or a capacitor-based ultrasonic piezoelectric element (CMUT) may be used as the piezoelectric element. A helium-neon (He-Ne) laser interferometer may be used as the laser interferometer.

When the magnetic field is applied, a deformation length in a saturation state may be measured using the piezoelectric element or the laser interferometer. When the deformation length may be denoted as ΔL, and when an original length is denoted as Lₒ, a saturation magnetostriction constant (λₛ) may be calculated as λₛ=ΔL/Lₒ.

However, even when the saturation magnetostriction constant is not directly measured as described above, a relative value of the saturation magnetostriction constant may be compared using the following indirect method.

For example, elements of the magnetic material and contents of the elements may be analyzed to identify a saturation magnetostriction constant value of the magnetic material. As will be described below, the elements of the magnetic material and the contents of the elements may be specified using transmission electron microscopy with energy dispersive spectroscopy (TEM-EDS) or scanning electron microscope (SEM) analysis on one cross-section of the body 100.

As another example, the saturation magnetostriction constant of the first magnetic material 11 may be less than the saturation magnetostriction constant of the second magnetic material 12. Thus, when samples of the first body 110 and the second body 120 are collected and a magnetic field is applied under the same conditions, a degree of deformation of the first magnetic material 11 may be less than a degree of deformation of the second magnetic material 12.

Hereinafter, the first magnetic material 11 is described, and subsequently the second magnetic material 12 is described.

For example, the first magnetic material 11 may be alloy powder particles including Fe and Si. Specifically, the first magnetic material 11 may be at least one of Fe-Si-based alloy powder particles, Fe-Si-Al-based alloy powder particles, Fe-Cr-Si-based alloy powder particles, Fe-Si-B-based amorphous alloy powder particles, Fe-Si-B-Cr-based amorphous alloy powder particles, Fe-Si-B-Cr-C-based amorphous alloy powder particles, Fe-Si-B-P-based amorphous alloy powder particles, and Fe-Si-B-Cu-Nb-based nanocrystalline alloy powder particles.

The first magnetic material 11 may include 6.5 wt % or more of silicon (Si) based on the total weight. When 6.5 wt % or more of silicon (Si) is included based on the total weight, the magnetostriction constant may have a negative value. When a content of silicon (Si) is less than 6.5 wt %, the saturation magnetostriction constant may have a positive value. For example, a Fe-6.5% Si alloy and a Fe-8% Si−2% Cr alloy may have magnetostriction constant values close to zero.

The first magnetic material 11 may preferably include 8 wt % or less of silicon (Si) based on the total weight. When the content of silicon (Si) is greater than 8 wt %, a high Si content may increase magnetic anisotropy, thereby reducing permeability. In this case, an absolute value of the magnetostriction constant may increase, which may result in an increase in vibrations. In addition, a saturation magnetic flux density (Bs) of the material may decrease, such that a DC superposition property may be degraded, which may degrade a static current property. As a result, it may be unpreferable.

Conversely, the second magnetic material 12 may include less than 6.5 wt % of silicon (Si) based on the total weight. The saturation magnetostriction constant of the second magnetic material 12 may have a positive value.

As an example of a method for analyzing elements of the Fe-based alloy and contents of the elements, TEM-EDS or SEM analysis may be used with respect to one cross-section of the body 100. More specifically, in FIG. 2, a composition of the Fe alloy included in the magnetic material may be obtained from an image of a cross-section in a second direction-third direction (Y-Z) of a middle portion of the body 100 in a first direction (X-direction). The composition may be an average value obtained by analyzing a plurality of magnetic particles at a plurality of points (for example, five points) equally spaced apart from each other in one cross-section. In addition, such analysis may be performed on a plurality of cross-sections of a magnetic body, and an average value may then be calculated.

For example, the first magnetic material 11 may include a nanocrystalline and an amorphous. Specifically, the nanocrystalline may be an Fe-based alloy, and may form an alloy with elements such as boron (B), silicon (Si), niobium (Nb), phosphorus (P), carbon (C), and copper (Cu). The nanocrystalline may be present as fine crystalline grain particles having a nanometer-scale size, dispersed in an amorphous matrix, and may account for 30% or more of the volume. An average grain size of nanocrystalline grains may be 50 nm or less. The matrix may be an amorphous matrix, and may have a positive magnetostriction constant, whereas precipitated nanocrystalline grains may have a negative magnetostriction constant. Accordingly, the magnetostriction constants may be mutually offset, resulting in a low magnetostriction value.

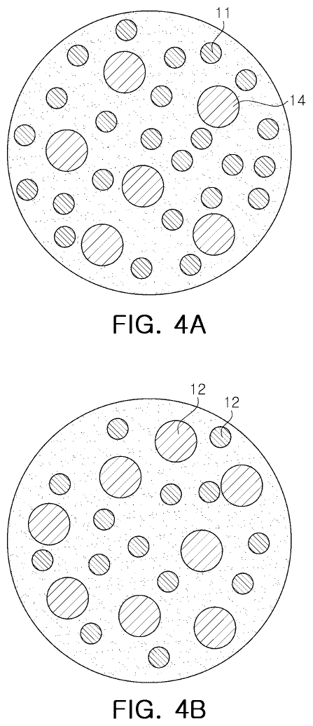

For example, referring to FIG. 4A, the first magnetic material 11 may include first pure iron particles. In addition, the first body 110 may further include a fourth magnetic material 14.

The first pure iron particles may be, for example, carbonyl iron powder (CIP) particles. The pure iron particles may have a negative magnetostriction constant value of −7 ppm, and may have a high saturation magnetic flux density (Bs), thereby minimizing degradation in Isat. The first pure iron particles may have a particle diameter of 0.1 μm to 10 μm, and may form relatively small magnetic particles.

The fourth magnetic material 14 may have a saturation magnetostriction constant greater than that of the first magnetic material 11.

As described above, pure iron may have a magnetostriction direction opposite to that of general magnetic particles. Accordingly, when the body 110 includes two or more types of magnetic materials 11 and 14, the body 110 may include pure iron particles, thereby reducing a magnetostriction phenomenon.

Conversely, the second body 120, including the second magnetic material 12, may not include pure iron particles. Alternatively, even when the second body 120 includes pure iron particles, a content of pure iron particles of the second body 120 may be less than that of pure iron particles of the first body 110.

When the bodies 110 and 120 include two or more types of magnetic materials, increasing a content of pure iron particles may further reduce a magnetostriction phenomenon. Accordingly, a magnetostriction phenomenon occurring in a lower portion of the coil component may be reduced by further increasing the content of pure iron particles of the first body 110 than that of pure iron particles of the second body 120.

Referring to FIGS. 4A and 4B, an area ratio occupied by first pure iron particles 11 in a cross-section of the first body 110 may be greater than an area ratio occupied by second pure iron particles 12 in the second body 120.

An area ratio of pure iron particles, present in the bodies 110 and 120, may be measured in a cross-section of the body 100 in a first direction-third direction. Specifically, with respect to the cross-section in the first direction-third direction passing through the center of the body 100, a plurality of regions (for example, ten regions), equally spaced apart from each other in a third direction, may be observed using an SEM. Using an image analysis program or the like, an area occupied by pure iron particles per unit area may be calculated to determine the area ratio. The area ratio may be an arithmetic average value of area ratios calculated with respect to the plurality of regions.

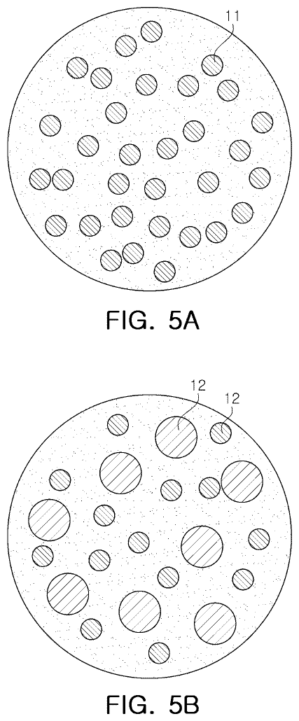

For example, referring to FIG. 5A, the first body 110, including the first magnetic material 11, may include only pure iron particles. That is, the first body 110 may not include magnetic materials other than pure iron particles. In this case, even when the first body 110 has a small volume (that is, even with a low content of pure iron particles), a magnetostriction phenomenon in a lower portion of the coil 300 may be effectively controlled.

The second magnetic material 12 may include ferrite or metal magnetic particles.

The ferrite may be, for example, at least one of spinel-type ferrite such as Mg-Zn-based ferrite, Mn-Zn-based ferrite, Mn-Mg-based ferrite, Cu-Zn-based ferrite, Mg-Mn-Sr-based ferrite, Ni-Zn-based ferrite, or the like, hexagonal ferrite such as Ba-Zn-based ferrite, Ba-Mg-based ferrite, Ba-Ni-based ferrite, Ba-Co-based ferrite, Ba-Ni-Co-based ferrite, or the like, garnet-type ferrite such as Y-based ferrite or the like, or Li-based ferrite.

Metal magnetic particles may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the metal magnetic particles may include one or more selected from pure iron powder, Fe-Si alloy powder particles, Fe-Si-Al alloy powder particles, Fe-Ni alloy powder particles, Fe-Ni-Mo alloy powder particles, Fe-Ni-Mo-Cu alloy powder particles, Fe-Co alloy powder particles, Fe-Ni-Co alloy powder particles, Fe-Cr alloy powder particles, Fe-Cr-Si alloy powder particles, Fe-Si-Cu-Nb alloy powder particles, Fe-Ni-Cr alloy powder particles, Fe-Cr-Al alloy powder particles, Fe-Si-B amorphous alloy powder particles, Fe-Si-B-Cr amorphous alloy powder particles, Fe-Si-B-Cr-C amorphous alloy powder particles, Fe-Si-B-P amorphous alloy powder particles, and Fe-Si-B-Cu-Nb nanocrystalline alloy powder particles.

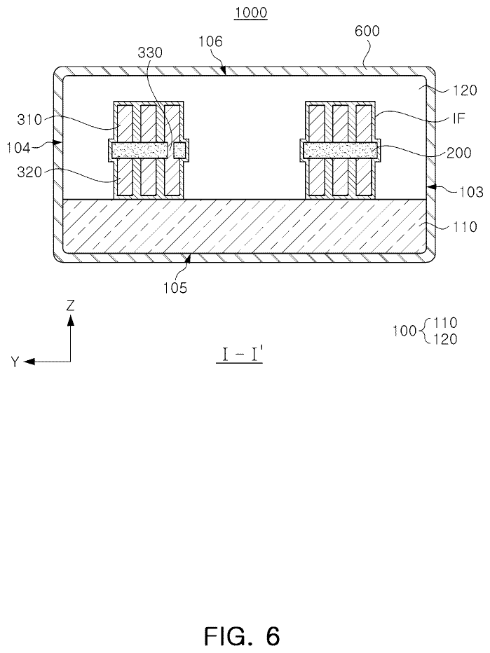

FIGS. 6 to 9 are views of various modifications of the first example embodiment of the present disclosure.

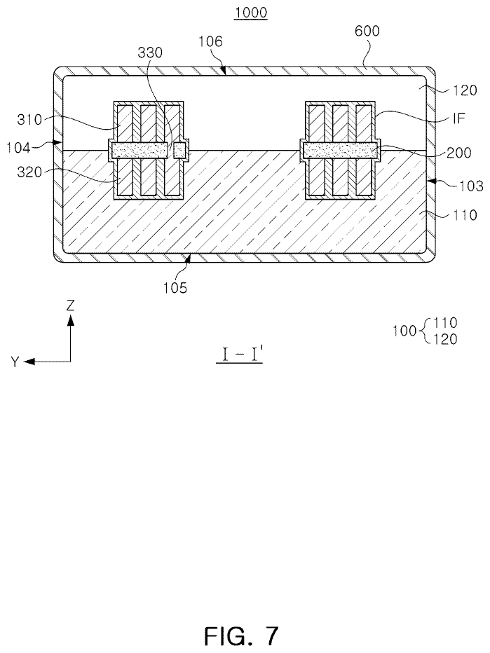

Referring to FIG. 6, the first body 110 may be in contact with a lower portion of the coil 300. Specifically, the first body 110 may be in contact with a coil insulating film IF. Referring to FIG. 7, the first body 110 may be formed up to a region higher than a lower surface of the coil 300. That is, at least a portion of the coil 300 may be disposed in the first body 110.

A magnetostriction property and a saturation current (Isat) may have a trade-off relationship. Accordingly, depending on a property of the saturation current (Isat) required by the coil component 1000, the entire lower portion of the coil 300 may be formed of the first body 110.

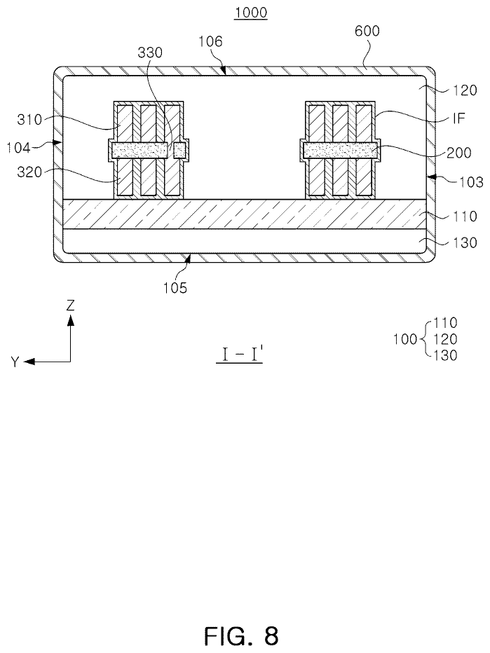

Referring to FIG. 8, a third body 130 may be disposed on one surface (lower surface) of the first body 110. The third body 130 may include a third magnetic material and a resin. A saturation magnetostriction constant of the first magnetic material 11 may be less than a saturation magnetostriction constant of the third magnetic material.

In the same manner as the second body 120 described above, the third body 130 may include magnetic particles having a relatively high saturation magnetostriction constant. The third body 130 may be disposed on a lower portion of the first body 110, and may be exposed to the fifth surface 105 of the body 100.

According to the present modification, magnetic particles having a relatively low saturation magnetostriction constant may be disposed only in a portion of the lower portion of the coil 300. That is, the first body 110 may be formed only in a portion of the body 100 in which magnetic flux density is concentrated, thereby effectively reducing a magnetostriction phenomenon.

The description of the third magnetic material may be the same as the description of the second magnetic material 12, and thus a detailed description will be omitted to avoid redundancy.

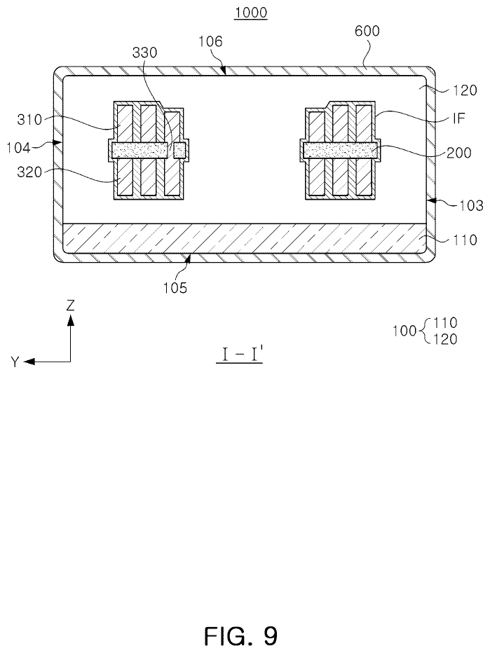

A modification according to FIG. 9 will be described after the description of the support member 200 and the coil 300.

The support member 200 may be buried in the body 100, and may support the coil 300 to be described below.

The support member 200 may be formed of an insulating material including at least one of a thermosetting insulating resin such as an epoxy resin, a thermoplastic insulating resin such as polyimide, and a photosensitive insulating resin, or an insulating material in which a reinforcing material such as a glass fiber or an inorganic filler is impregnated into the above-described insulating resins. For example, the support member 200 may be formed of an insulating material such as a copper clad laminate (CCL), a prepreg, an Ajinomoto build-up film (ABF), FR-4, a bismaleimide triazine (BT) resin, or a photoimageable dielectric (PID), but the present disclosure is not limited thereto.

At least one selected from the group consisting of silica (SiO₂), alumina (Al₂O₃), silicon carbide (SiC), barium sulfate (BaSO₄), talc, clay, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃) may be used as the inorganic filler.

When the support member 200 is formed of an insulating material including a reinforcing material, the support member 200 may provide more excellent rigidity. When the support member 200 is formed of an insulating material not including a glass fiber, the support member 200 may be advantageous in reducing an overall thickness of the coil 300. When the support member 200 is formed of an insulating material including a photosensitive insulating resin, the number of processes for forming the coil 300 may be reduced, which may be advantageous in reducing production costs, and a fine via may be formed.

The coil 300 may be disposed in the body 100 to exhibit properties of the coil component. For example, when the coil component 1000 according to the present example embodiment is used as a power inductor, the coil 300 may serve to stabilize power of an electronic device by storing an electric field as a magnetic field and maintaining an output voltage.

Referring to FIG. 2, at least a portion of the coil 300 may be disposed in a second region 120 of a body 100. As described above, the first body 110 may be formed only in a lower region of the coil 300, such that the coil 300 may not be disposed in the first body 110, but the present disclosure is not limited thereto. As illustrated in FIG. 7, the coil 300 may be disposed across the first body 110 and the second body 120.

The coil 300 may be disposed on one surface of the support member 200, and may form a plurality of turns. In the present example embodiment, the coil 300 may include a first coil pattern 310 disposed on one surface of the support member 200 opposing the sixth surface 106 of the body 100, a second coil pattern 320 disposed on the other surface of the support member 200, and a via 330 passing through the support member 200 to connect the first coil pattern 310 and the second coil pattern 320 to each other. As a result, the coil 300 according to the present example embodiment may be formed as a single coil generating a magnetic field in a third direction (Z-direction) of the body 100 with respect to a core.

Each of the first coil pattern 310 and the second coil pattern 320 may have a planar spiral shape forming at least one turn using a core 110 of the body 100 as an axis. For example, in the directions of FIGS. 1 and 2, the first coil pattern 310 may form a plurality of turns on an upper surface of the support member 200 using the core as an axis. The second coil pattern 320 may form a plurality of turns on a lower surface of the support member 200 using the core as an axis.

One end of the first coil pattern 310 may extend to the first surface 101 of the body, and may be connected to a first external electrode 400 to be described below, and the other end of the first coil pattern 310 may be connected to the via 330. One end of the second coil pattern 320 may extend to the second surface 102 of the body, and may be connected to a second external electrode 500 to be described below, and the other end of the second coil pattern 320 may be connected to the via 330.

At least one of the coil patterns 310 and 320 and the via 330 may include at least one conductive layer.

For example, when the first coil pattern 310 and the via 330 are formed by plating, each of the first coil pattern 310 and the via 330 may include a seed layer formed by vapor deposition such as electroless plating or sputtering, and an electrolytic plating layer. Here, the electrolytic plating layer may have a single-layer structure or a multilayer structure. The electroplating layer having a multilayer structure may be formed in a conformal film structure in which one electroplating layer covers another electroplating layer, or may be formed in a shape in which one electroplating layer is laminated only on one surface of another electroplating layer. The seed layers of the first coil pattern 310 and the via 330 may be integrally formed, such that boundaries therebetween may not be formed, but the present disclosure is not limited thereto. The electrolytic plating layers of the first coil pattern 310 and the via 330 may also be integrally formed, such that boundaries therebetween may not be formed, but the present disclosure is not limited thereto.

Each of the coil patterns 310 and 320 and the via 330 may be formed of a conductive material such as copper (Cu), aluminum (Al), silver (Ag), tin (Sn), gold (Au), nickel (Ni), lead (Pb), titanium (Ti), molybdenum (Mo), or alloys thereof, but the present disclosure is not limited thereto.

Referring to FIG. 9, in one modification, a thickness of the coil 300 may vary between an innermost turn of the coil 300 and an outer turn of the coil 300.

Specifically, in the first coil pattern 310, a thickness of an innermost turn may be less than a thickness of an outer turn. When the coil 300 is biased toward an upper portion of the body 100, magnetic flux density may be concentrated in an upper portion of the coil component, and a DC bias property may be degraded. Accordingly, an area through which magnetic flux passes may be increased by reducing the thickness of the innermost turn of the first coil pattern 310 in which magnetic flux is concentrated, thereby preventing concentration of magnetic flux density in an upper portion of the coil 300.

The first and second external electrodes 400 and 500 may be disposed on the first surface 101 and the second surface 102 of the body 100, respectively. The first external electrode 400 may be disposed on the first surface 101 of the body 100, and may be connected to one end of the first coil pattern 310. The second external electrode 500 may be disposed on the second surface 102 of the body 100, and may be connected to one end of the second coil pattern 320.

The first and second external electrodes 400 and 500 may have a structure including a single layer or a plurality of layers. For example, the first external electrode 400 may include a first layer including copper (Cu), a second layer disposed on the first layer, the second layer including nickel (Ni), and a third layer disposed on the second layer, the third layer including tin (Sn). Here, the first to third layers may be formed by plating, respectively, but the present disclosure is not limited thereto. As another example, the first external electrode 400 may include a resin electrode including conductive powder particles, such as silver (Ag), and a resin, and a nickel (Ni)/tin (Sn) plating layer formed on the resin electrode.

The first and second external electrodes 400 and 500 may be formed of a conductive material such as copper (Cu), aluminum (Al), silver (Ag), tin (Sn), gold (Au), nickel (Ni), lead (Pb), titanium (Ti), or alloys thereof, but the present disclosure is not limited thereto.

Referring to FIG. 2, an insulating film IF may be disposed along a surface of the coil 300.

The insulating film IF may electrically insulate between the coil 300 and the body 100. The insulating film IF may cover an external surface of the coil 300 to insulate the coil 300 from the body 100. The insulating film IF may be formed in the form of a conformal film along the external surface of the coil 300.

The insulating film IF may include a known insulating material such as parylene or the like, but the present disclosure is not limited thereto. As another example, the insulating film IF may include an insulating material such as an epoxy resin or the like, rather than parylene. The insulating film IF may be formed using a vapor deposition method, but the present disclosure is not limited thereto. As another example, the insulating film IF may be formed by laminating and curing an insulating film for forming the insulating film IF on both surfaces of the support member 200 on which the coil 300 is formed, and the insulating film IF may be formed by coating and curing an insulating paste for forming the insulating film IF on both surfaces of the support member 200 on which the coil 300 is formed.

In the present disclosure, the insulating film IF may be an optional element. When the body 100 is capable of securing sufficient electrical resistance under an operating condition of the coil component 1000 according to the present example embodiment, the insulating film IF may be omitted.

The insulating layer 600 may be disposed on a surface of the body 100 to prevent the body 100 from being exposed to the outside of the coil component. Specifically, the insulating layer 600 may be disposed on regions of the third surface 103, the fourth surface 104, the fifth surface 105, and the sixth surface 106 of the body 100 on which the external electrodes are not formed. The insulating layer 600 may be disposed on the surface of the body 100 on which the external electrodes 400 and 500 are not formed, and may serve to electrically protect the coil component, reduce leakage current, and prevent plating spread during formation of the external electrodes.

The insulating layer 600 may include a thermoplastic resin such as a polystyrene-based resin, a vinyl acetate-based resin, a polyester-based resin, a polyethylene-based resin, a polypropylene-based resin, a polyamide-based resin, a rubber-based resin, an acryl-based resin, or the like, a thermosetting resin such as a phenol-based resin, an epoxy-based resin, a urethane-based resin, a melamine-based resin, an alkyd-based resin, or the like, a photosensitive resin, parylene, SiOₓ or SiNₓ.

### Second Example Embodiment

A coil component 2000 according to a second example embodiment may be a wound-type coil component. Hereinafter, only a portion, a difference between the wound-type coil component and the coil component 1000 according to the first example embodiment, will be described. The description of the first example embodiment may be equally applied to remaining portions.

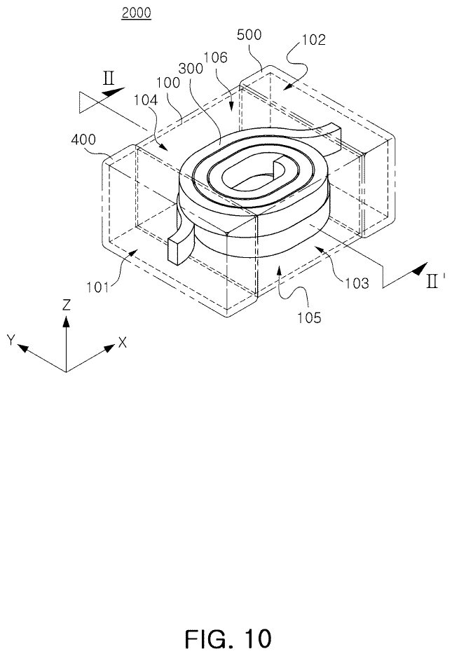

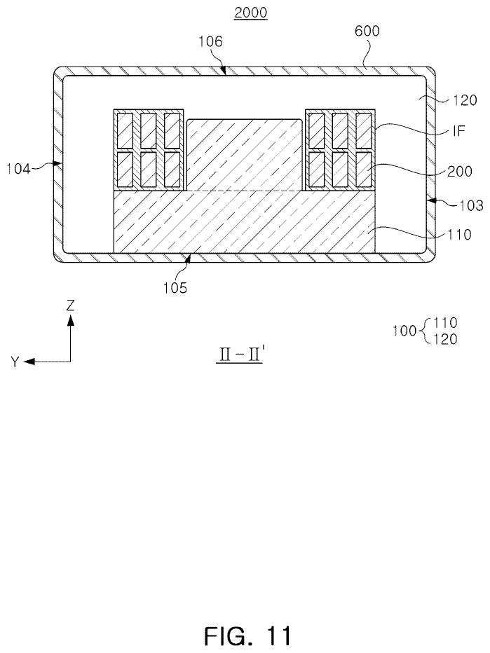

FIG. 10 is a perspective view of a coil component according to the second example embodiment of the present disclosure. FIG. 11 is a schematic cross-sectional view taken along line II-II′ of FIG. 10.

Referring to FIGS. 10 and 11, shapes of a first body and a second body may be different from those in the first example embodiment.

A second body 120 may be disposed on an upper portion of a first body 110, and may surround all surfaces of the first body 110 except for a lower surface of the first body 110. Accordingly, a first surface, a second surface, a third surface, a fourth surface, and a sixth surface of a body 100 may be formed by the second body 120, and a fifth surface 105 of the body 100 may be formed by the first body 110.

The first body 110 may support a wound coil 300, and may include a core passing through at least a portion of the wound coil 300.

The second body 120 may cover the first body 110 and the wound coil 300. The second body 120 may be disposed on the first body 110 and the wound coil 300, and then may be pressurized and coupled to the first body 110.

The wound coil 300 may be disposed on an upper surface of the first body 110, and may be wound around the core. The wound coil 300 may be formed by winding a metal wire, such as a copper wire having a surface coated with an insulating film IF, into a spiral shape. As a result, each turn of the wound coil 300 may be coated with the insulating film IF.

Both ends of the wound coil 300 may extend to a first surface 101 and a second surface 102 of the body 100, and may be connected to external electrodes 400 and 500.

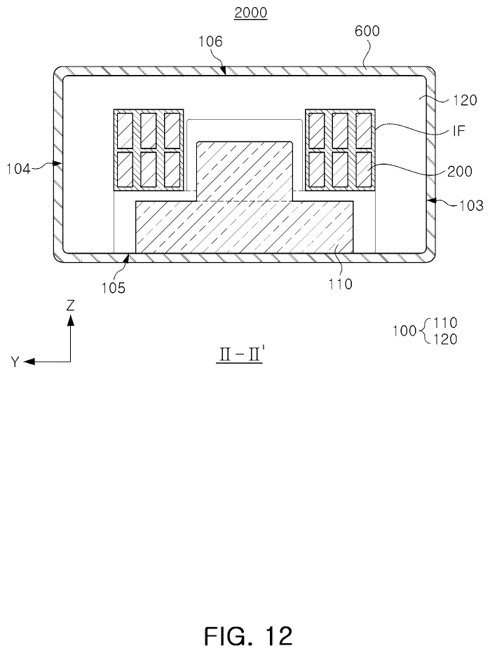

Referring to FIG. 12, the first body 110 may have a small size, as compared to that in FIG. 11.

In the present modification, a molded portion of a wound-type coil component may be double-molded. The first body 110 may be disposed on the inside of the molded portion, and the second body 120 may be disposed on the outside of the molded portion.

The first body 110 may not be in contact with the wound coil 300.

The second body 120 may be disposed on the outside of the molded portion and a cover portion, and a boundary may not be formed therebetween.

### Third Example Embodiment

A coil component 3000 according to a third example embodiment may be a multilayer coil component. Hereinafter, only a portion, a difference between the multilayer coil component and the coil component 1000 according to the first example embodiment, will be described. The description of the first example embodiment may be equally applied to remaining portions.

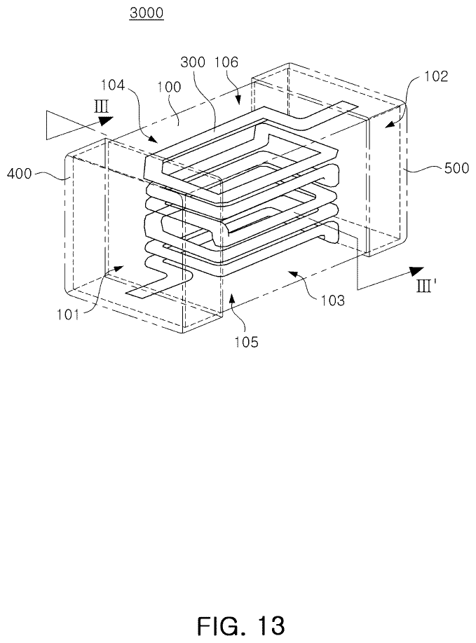

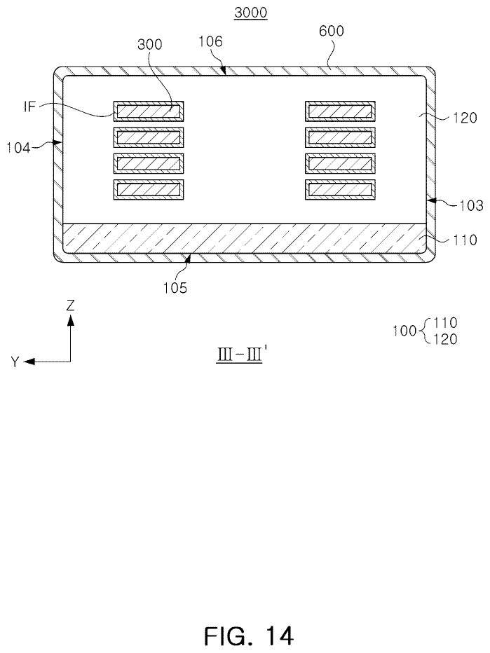

FIG. 13 is a perspective view of a coil component according to a third example embodiment of the present disclosure. FIG. 14 is a schematic cross-sectional view taken along line III-III′ of FIG. 13.

Referring to FIG. 13, a body 100 may be formed by laminating a plurality of magnetic sheets in a third direction (Z-direction), and a coil 300 may be formed on the plurality of magnetic sheets.

A first body 110 may be disposed on a lower portion of the coil 300, and may have a form in which a plurality of magnetic sheets are laminated. Similarly, a second body 120 may be disposed on an upper portion, the first body 110, and may have a form in which a plurality of magnetic sheets are laminated.

That is, the body 100 of the coil component 3000 according to the third example embodiment may be formed by laminating a plurality of magnetic sheets including a magnetic material in the third direction (Z-direction) and then sintering the plurality of magnetic sheets. A conductor pattern may be formed on one surface of each of the plurality of magnetic sheets, and the conductor patterns may be electrically connected to each other through conductive vias formed in adjacent magnetic sheets to form the coil 300.

The conductor pattern may be formed by thick-film printing, coating, deposition, and sputtering a conductive paste for forming a conductor pattern on a green sheet for forming the magnetic sheet, but the present disclosure is not limited thereto.

The conductive vias may be formed by forming through-holes of the sheets in a thickness direction and filling the through-holes with a conductive paste or the like, but the present disclosure is not limited thereto.

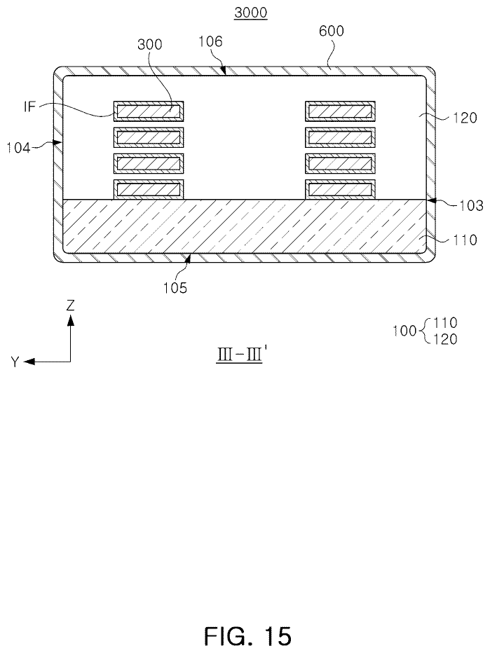

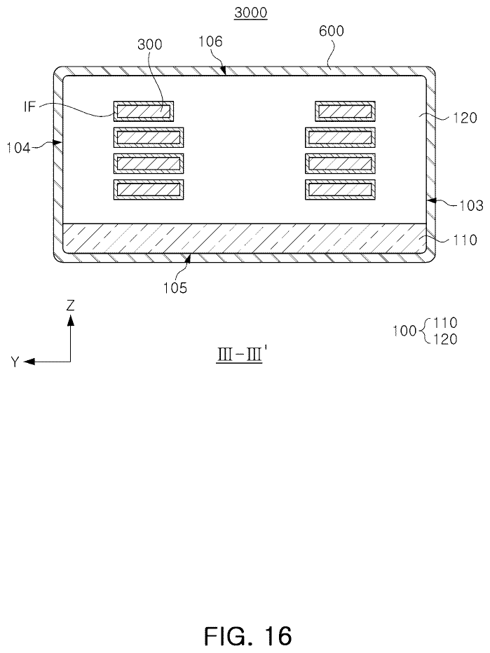

FIGS. 15 and 16 are views of modifications of the third example embodiment of the present disclosure.

Referring to FIG. 15, the first body 110 may be in contact with a lower portion of the coil 300. Depending on a saturation current (Isat) property required by the coil component 3000, the entire lower portion of the coil 300 may be formed of the first body 110.

Referring to FIG. 16, a width of an uppermost turn of the coil 300 may be less than that of a lower turn of the coil 300. When the coil 300 is biased toward an upper portion of the body, magnetic flux density may be concentrated in an upper portion of the coil component, and a DC bias property may be degraded. Accordingly, the width of the uppermost turn of the coil in which magnetic flux is concentrated may be reduced, thereby preventing concentration of magnetic flux density in an upper portion of the coil 300.

While example embodiments have been shown and described above, it will be apparent to those skilled in the art that modifications and variations could be made without departing from the scope of the present disclosure as defined by the appended claims.

What is claimed is:

1. A coil component comprising:
a first body including a first magnetic material;
a second body disposed on an upper surface of the first body, the second body including a second magnetic material;
an insulating layer disposed on an upper surface of the second body; and
a coil at least partially disposed in the second body, the coil extending to a surface of the second body,
wherein a saturation magnetostriction constant of the first magnetic material is less than a saturation magnetostriction constant of the second magnetic material.

2. The coil component of claim 1, wherein the saturation magnetostriction constant of the first magnetic material has a negative value or a value of 1 part per million (ppm) or less.

3. The coil component of claim 1, wherein the first magnetic material includes first pure iron particles.

4. The coil component of claim 3, wherein
the second magnetic material includes second pure iron particles, and
an area ratio occupied by the first pure iron particles in a cross-section of the first body is greater than an area ratio occupied by the second pure iron particles in the second body.

5. The coil component of claim 1, wherein the first magnetic material includes a nanocrystalline and an amorphous.

6. The coil component of claim 1, wherein
the first magnetic material includes Fe and Si, and
a content of Si in the first magnetic material is 6.5 wt % or more and 8 wt % or less.

7. The coil component of claim 6, wherein
the second magnetic material includes Fe and Si, and
a content of Si in the second magnetic material is less than 6.5 wt %.

8. The coil component of claim 1, further comprising:
a third body disposed on a lower surface of the first body, the third body including a third magnetic material,
wherein the saturation magnetostriction constant of the first magnetic material is less than a saturation magnetostriction constant of the third magnetic material.

9. The coil component of claim 1, wherein
the first body further includes a fourth magnetic material, and
a saturation magnetostriction constant of the fourth magnetic material is greater than the saturation magnetostriction constant of the first magnetic material.

10. The coil component of claim 1, wherein the coil is at least partially disposed in the first body.

11. The coil component of claim 1, wherein a distance from an upper surface of the coil to the upper surface of the second body is less than a distance from a lower surface of the coil to a lower surface of the first body.

12. The coil component of claim 1, further comprising:
an external electrode covering both side surfaces of the first body and both side surfaces of the second body, the external electrode connected to the coil.

13. The coil component of claim 1, wherein a thickness of an innermost turn of the coil is less than a thickness of an outer turn of the coil.

14. A coil component comprising:
a body including a first body and a second body disposed on an upper surface of the first body, the body including pure iron particles;
an insulating layer disposed on an upper surface of the second body; and
a coil at least partially disposed in the second body, the coil extending to a surface of the second body;
wherein an area ratio occupied by the pure iron particles in a cross-section of the first body is greater than an area ratio occupied by the pure iron particles in a cross-section of the second body.

15. The coil component of claim 14, wherein
the body further includes a third body disposed on a lower surface of the first body, and
the area ratio occupied by the pure iron particles in the cross-section of the first body is greater than an area ratio occupied by the pure iron particles in a cross-section of the third body.

16. The coil component of claim 14, wherein the first body is positioned on a lower portion of the coil.

17. The coil component of claim 14, wherein the second body does not include the pure iron particles.

18. The coil component of claim 14, wherein a thickness of an innermost turn of the coil is less than a thickness of an outer turn of the coil.
